(19) United States
(12) Patent Application Publication
(10) Pub. No.: US 2006/0223584 A1
(43) Pub. Date: Oct. 5, 2006

(54) Notify me service in wireless networks

(75) Inventor: Alok Sharma, Lisle, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/094,032

(22) Filed: Mar. 30, 2005

(51) Int. Cl. H04M 11/00; H04M 1/00

(52) U.S. Cl. 455/560

(57) ABSTRACT

A wireless network that provides notify me service for calls directed to called stations not currently registered on a network. A wireless network includes a network interface that serves a call from a calling station, and a called station network that serves a called station. The calling station initiates a call to the called station through the network interface to the called station network. The called station network determines that the called station is not currently registered on the network. Responsive to the called station not being registered, the network interface receives a notify me dialing instruction from the calling station and transmits a notify me dialing indicator to the called station network. The called station network determines when the called station registers, and transmits an indication for receipt by the calling station that the called station is registered.

### BACKGROUND

1. Field of the Invention

This invention relates to apparatus and methods for providing notify me service in communication networks and, in particular, in wireless communication networks.

2. Statement of the Problem

Telephone subscribers are currently offered various service features that attempt the successful completion of a call regardless of the state of the called station when the call is attempted. These services are provided to ensure that a calling station will ultimately be successful in contacting the called station even if the called station is unavailable when the call is first attempted.

Such features include voicemail, which permits a caller to leave a message for the called station. Other such features include service that completes a connection to a called station upon the dialing of special code for a call that is not answered in time to establish a call connection. Another such service is that by which the telephone company, for a nominal fee, completes the attempted call to a busy station as soon as the called station becomes idle.

Another feature offered to traditional wire line subscribers is repeated dialing of busy numbers. In accordance with this feature, an originating switch routes a call to a terminating switch serving the called station. The terminating switch determines that the called station is busy and signals the calling station with a busy tone. The caller can enter a special code to activate the repeated dialing feature. The caller can then hangs up and the telephone network sets up a connection to the called station when it becomes available.

It is a problem that the above features are only offered for wire line networks and not for cellular or wireless networks. It is a further problem that some of the above features are not effective in establishing a connection to a wireless station since a wireless user may turn off a cell phone. In this case, the cell phone is no longer turned-on (not registered with the wireless network) and cannot receive a call until the cell phone is turned-on (registered with the wireless network). This is a problem for calling parties wishing to establish a connection to an unregistered cell phone since they do not wish to waste their time with repeated dialing, yet they may have an urgent need to establish a connection to the cell phone.

### SUMMARY OF THE SOLUTION

The invention solves the above and other related problems by providing notify me service for calls directed to a wireless station that is not registered on a wireless network. In accordance with the present invention, notify me service may originate for a call originating in a calling station of a landline network or a wireless, mobile or cellular network. Further in accordance with the present invention, the called station may be served by a wireless, mobile or cellular network.

Notify me service is implemented by a called station network serving a called station not registered on the wireless network. Information is stored regarding the status of each station served by the called station network. The called station network determines the status of a called station upon the receipt of a call directed to the called station. At that time, the called station network determines whether a called station is registered (e.g., powered on) and therefore available to receive calls, or whether it is not currently registered (e.g., powered off) and unable to receive calls. If the called station is not registered, the called station network takes the actions required to provide a notification to the calling station that the called station is not currently registered and therefore not available to receive calls. The calling station can then activate the notify me service. Using this service, the calling station can be notified when the called station registers with the wireless network and is once again able to receive calls.

If the calling station wishes to active the notify me service, the called station, responsive to commands from a user, transmits a notify me dialing instruction to the wireless network. The called station network in the wireless network receives a notify me dialing indicator and stores the notify me dialing indicator. The called station network then monitors the status of the called station. The called station network determines when the called station subsequently registers with the wireless network (e.g., powers on). At that time, the called station network transmits an indication for receipt by the calling station that the called station has registered with the wireless network. The user of the calling station is thus informed when the called station has registered.

The indication provided by the wireless network to the calling station may be provided by a message center in the wireless network. For instance, the message center may comprise a Short Message Service Center (SMSC), a Multi-Media Center (MMC), or another type of message center. To provide the indication to the calling station, the called station network transmits an instruction to the message center to provide a message to the calling station. The instruction from the called station network may also provide the content of the message. Responsive to the instruction from the called station network, the message center generates a message, such as a text message, a data message, etc, and transmits the message to the calling station. The message then informs the user of the calling station that the called station is now registered.

### DESCRIPTION OF THE DRAWINGS

The same reference number represents the same element on all drawings.

FIG. 1 illustrates a wireless network in an exemplary embodiment of the invention.

FIG. 2 is a message diagram illustrating the notify me service by the network of FIG. 1 in an exemplary embodiment of the invention.

FIG. 3 illustrates a communication network in another exemplary embodiment of the invention.

FIGS. 4-5 are message diagrams illustrating the processes of providing notify me service in the network of FIG. 3.

FIG. 6 discloses an alternative embodiment of the invention.

### DETAILED DESCRIPTION OF THE INVENTION

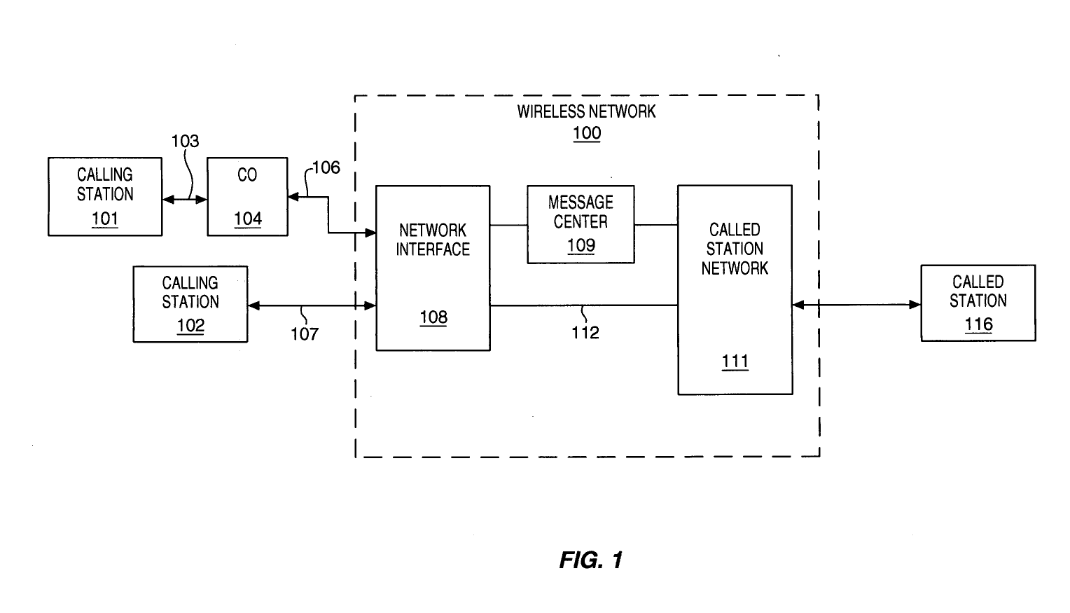

FIGS. 1-6 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a wireless network 100 in an exemplary embodiment of the invention. Wireless network 100 includes a network interface 108, a message center 109 and a called station network 111. Wireless network 100 is connected to called station 116 on its right side and on its left side is connected via path 107 to calling station 102. Network 100 is further connected on his left side by a path 106 to a central office 104 and, in turn, over path 103 to a calling station 101. Wireless network 100 may be connected to other stations on its left side and other stations on its right side. Calling station 102 is connected to wireless network 100 and network interface 108 within wireless network 100. Calling station 102 may advantageously be of the mobile or wireless type, such as a cell phone. Calling station 101 may comprise landline facilities, which can exchange calls with wireless network 100 by means of central office 104 and network interface 108.

Wireless network 100 may be of any size ranging from a small cell phone facility serving a plurality of cells as well as upwards to a nationwide, multi-city network. Path 112 within wireless network 100 may comprise communications facilities of any type ranging from a wire connection to packet network or any other type of transmission facility suitable for the exchange of information between the elements of wireless network 100.

Calling station 102 may include any type of mobile communication device, such as a mobile phone, a PDA, etc, that is portable or mobile and transmits and receives messages via wireless signals. Calling station 101 may also include a wire line communication device, such as a traditional telephone, Voice over Internet Protocol (VoIP) phone, etc, or any other device that communicates over wire lines. Called station 116 may include any type of device that is mobile or portable, and transmits and receives messages via wireless signals.

The representation of wireless network 100 on FIG. 1 is simplified to minimize its complexity. It should be understood that wireless network 100 may comprise other elements and facilities necessary for the operation of wireless network 100. Because of its connection via path 107 with wireless network 100, calling station 102 would advantageously be of the wireless type. Calling station 101 and central office 104 on the other hand are of the landline type and can exchange calls with wireless network 100 by means of network interface 108. Network interface 108 may comprise a plurality of instrumentalities as required to enable it to serve both wireless facilities such as calling station 102 as well as landline facilities such as central office 104 and calling station 101. One example of network interface 108 is a Mobile Switching Center (MSC).

A call is served in the wireless network 100 of FIG. 1 when a caller dials the number of a called station, such as called station 116. The dialed number and information pertaining to the calling station 102 are extended over paths 106 or 107 to network interface 108 of wireless network 100. Network interface 108 performs its functions in serving the call and extends the dialed number and any other relevant call information over path 112 to called station network 111. Called station network 111 comprises any portion of wireless network 100 that serves called station 116. Called station network 111 may include an MSC for serving called station 116 when called station 116 is powered on, and a Home Location Register (HLR) for called station 116.

A call is completed to called station 116 in a conventional manner if called station 116 is registered on the network and is idle. A call cannot be completed if called station 116 is not registered on the network. “Registered” is defined in this embodiment as the called station 116 being powered on and communicating with called station network 111. Called station 116 is “not registered” if called station 116 is powered off and not communicating with called station network 111.

If the call cannot be completed, called station network 111 provides an indication to the calling station that called station 116 is not registered. If the user of the calling station is interested in notify me service, the user may take further actions, such as the dialing of special codes to advise called station network 111 that the user wishes to receive notify me service. This code (also referred to as a notify me dialing instruction) is transmitted via network interface 108 to called station network 111, which stores a notify me dialing indicator. Called station network 111 monitors called station 116 and provides an indication to the calling station when called station 116 has again registered with the network.

The transmitted indication may take various forms depending upon the functionality of the apparatus embodying the calling station. Let it first be assumed that calling station 102 is to receive the indication. Calling station 102 is of the mobile or cell phone type and is equipped to receive text or visual messages. In this case, the indication may be a text, data or visual message. This message and/or accompanying visual indication advises calling station 102 that called station 116 is registered. Secondly, assume that calling station 101 is to receive the indication. If calling station 101 is a conventional “black phone”, the transmitted indication may be a coded or specialized ringing possibly followed by a recorded announcement stating that called station 116 is registered. On the other hand, calling station 101 may possibly be associated with adjunct apparatus equipped to receive text and or visual information. In this case, the calling station 101 may receive may be a text, data or visual message in the same manner as above described for calling station 102.

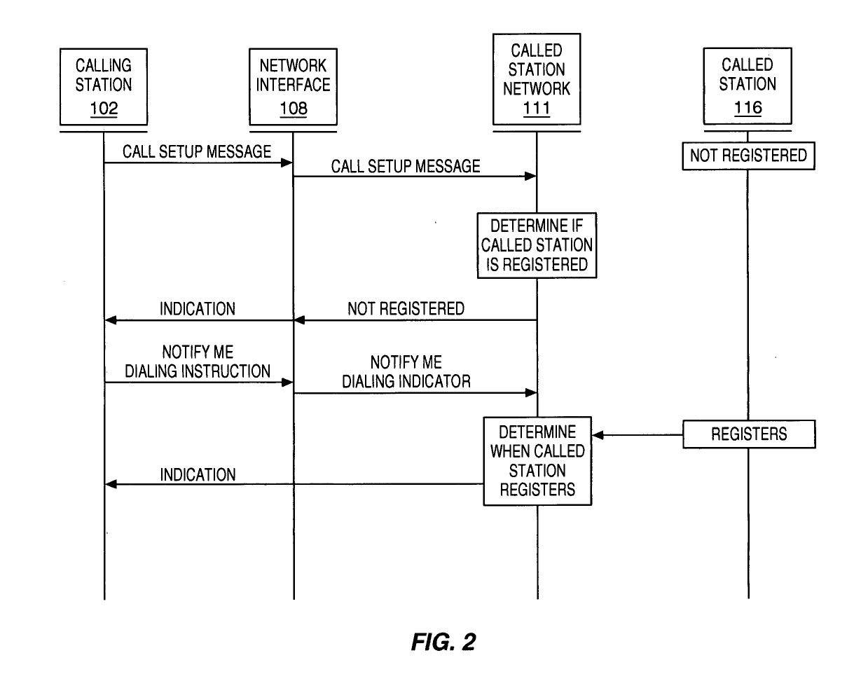

FIG. 2 is a message diagram illustrating the provision of notify me service in wireless network 100 of FIG. 1 in an exemplary embodiment of the invention. Calling station 102 initiates a call to mobile called station 116 with a call setup message. Network interface 108 receives the call setup message, and transmits the same or another call setup message to called station network 111. Called station network 111 determines that called station 116 is not currently registered and transmits a not registered message as well as other information to network interface 108. Network interface 108 transmits some indication to calling station 102 that called station 116 is not registered. For instance, network interface 108 may transmit an announcement to calling station 102 indicating that called station 116 is not registered. Network interface 108 may transmit a no-answer signal to calling station 102 (e.g., rings with no answer). Network interface 108 may also route the call to a voice mail server for called station 116, which indicates to calling station 102 that called station 116 is not registered (e.g., powered off).

Upon receipt of the indication from network interface 108, the caller takes appropriate action to activate the notify me service. Through calling station 102, the user of calling station 102 enters a code or some other type of instruction. Calling station 102 transmits a notify me dialing instruction to network interface 108. Network interface 108 receives a notify me dialing instruction from calling station 102, and transmits a corresponding notify me dialing indicator to called station network 111. The notify me dialing indicator may comprise any data, flag, code, or other indicia that indicates that the notify me service has been activated by the user of calling station 102. Network interface 108 may also transmit a Mobile Station Identifier (MSID) of calling station 102 to called station network 111 with the notify me dialing indicator. Called station network 111 may store the notify me dialing indicator and possibly the MSID for calling station 102 in a subscriber record for called station 116. At this point, the notify me service is activated.

Called station network 111 then determines when called station 116 registers with wireless network 100. Responsive to determining that called station 116 registered, called station network 111 transmits an indication that is received by calling station 102 indicating that called station 116 has registered. The user of calling station 102 may then dial the called station 116 to attempt to set up a call.

Communication network 100 advantageously provides an effective way of implementing notify me service to mobile devices. Because called station network 111 serves called station 116, called station network 111 is in a position to real-time monitor when called station 116 registers. Based on the real-time monitoring, called station network 111 can effectively initiate the actions required to notify calling station 102 when called station 116 registers.

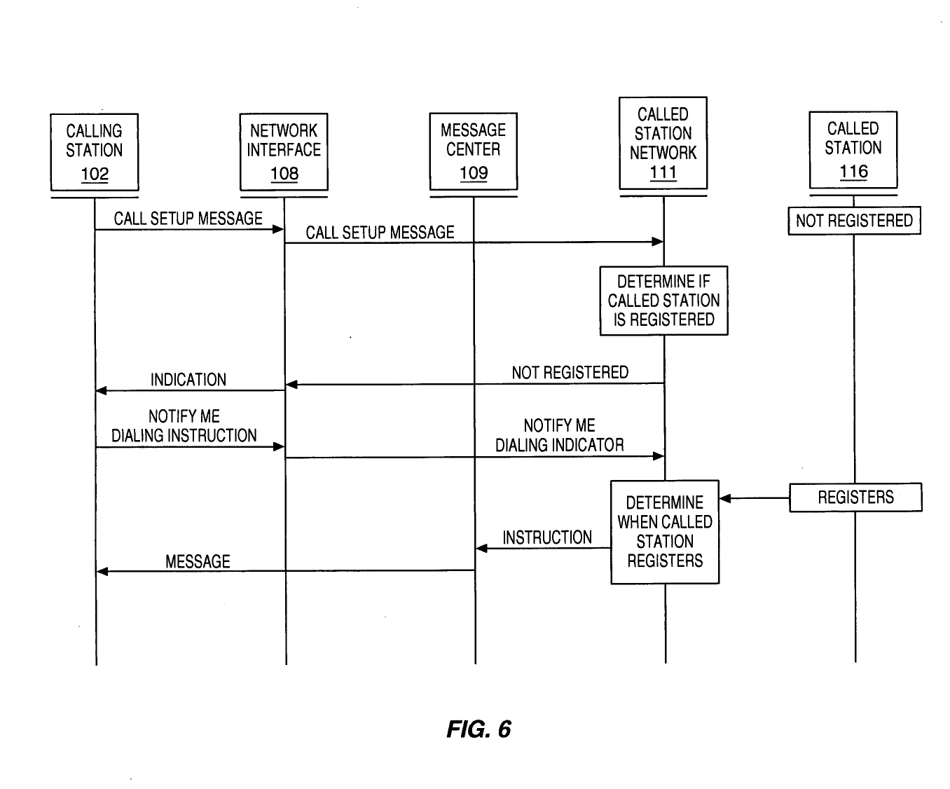

FIG. 6 is a message diagram illustrating another way of providing notify me service in wireless network 100 of FIG. 1 in an exemplary embodiment of the invention. The process described in FIG. 6 uses message center 109 (see FIG. 1) to notify calling station 102 when called station 116 registers. The process in FIG. 6 operates in the same manner as in FIG. 2 until called station network 111 determines that called station 116 registers. When called station network 111 determines that called station 116 registers, called station network 111 generates an instruction and transmits the instruction to message center 109. The instruction instructs message center 109 to transmit a message to calling station 102 indicating that called station 116 has registered with wireless network 100. The instruction may also include the content for the message. Responsive to receiving the message, message center 109 generates a message, such as a text message, a data message, etc, and transmits the message to calling station 102 through network interface 108.

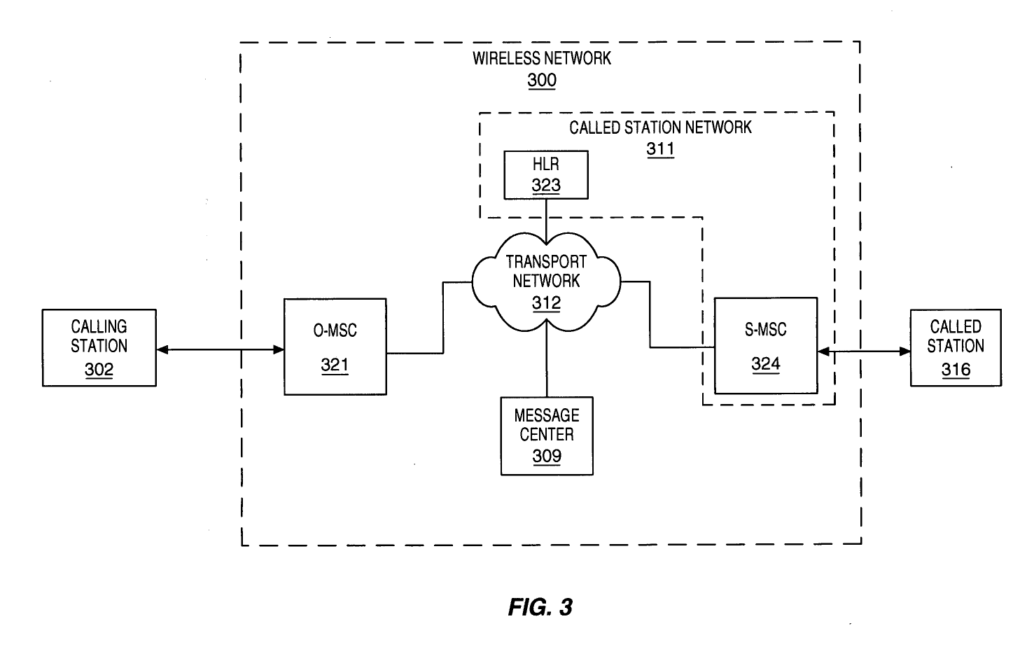

FIG. 3 illustrates wireless network 300 embodying another possible embodiment of the invention. Wireless network 300 includes originating network O-MSC 321 which embodies network interface 108 of FIG. 1. Wireless network 300 also includes called station network 311 that includes S-MSC 324 for serving called station 316, and HLR 323 for called station 316. HLR 323 is shown separate from S-MSC 324, but may be integral to S-MSC 324 in other embodiments. O-MSC 321, S-MSC 324, and HLR 323 are connected to transport network 312. Transport network 312 may comprise a circuit-based network, a packet-based network, or another type of network.

Wireless network 300 also includes message center 309. Message center 309 is connected to transport network 312 and works in conjunction with HLR 323 in called station network 311 to transmit information in the form of messages from HLR 323 in called station network 311 to calling station 302 when an indication is to be provided to calling station 302 in conjunction with the provision of notify me service. The function of message center 309 is to receive an instruction and content from HLR 323 and provide a message to calling station 302. The message may be of any type such as text messages, data, video, or any other type of information or signals that is to be received by calling station 302, regardless of its type, in conjunction with the provision of its call serving functions. Message center 309 may comprise a Short Message Service Center (SMSC) that generates text messages. Message center 309 may alternatively comprise a Multimedia Message Center (MMC) that generates multimedia messages, such as large text messages, video, pictures, etc.

Message center 309 receives the content for the messages from HLR 323 in called station network 311. Message center 309 generates the messages based on the content it receives from HLR 323, and transmits the messages to calling station 302. The function of message center 309 in conjunction with the present invention is to transmit information in the form of messages to calling station 302 when a called station 316 registers or is powered on.

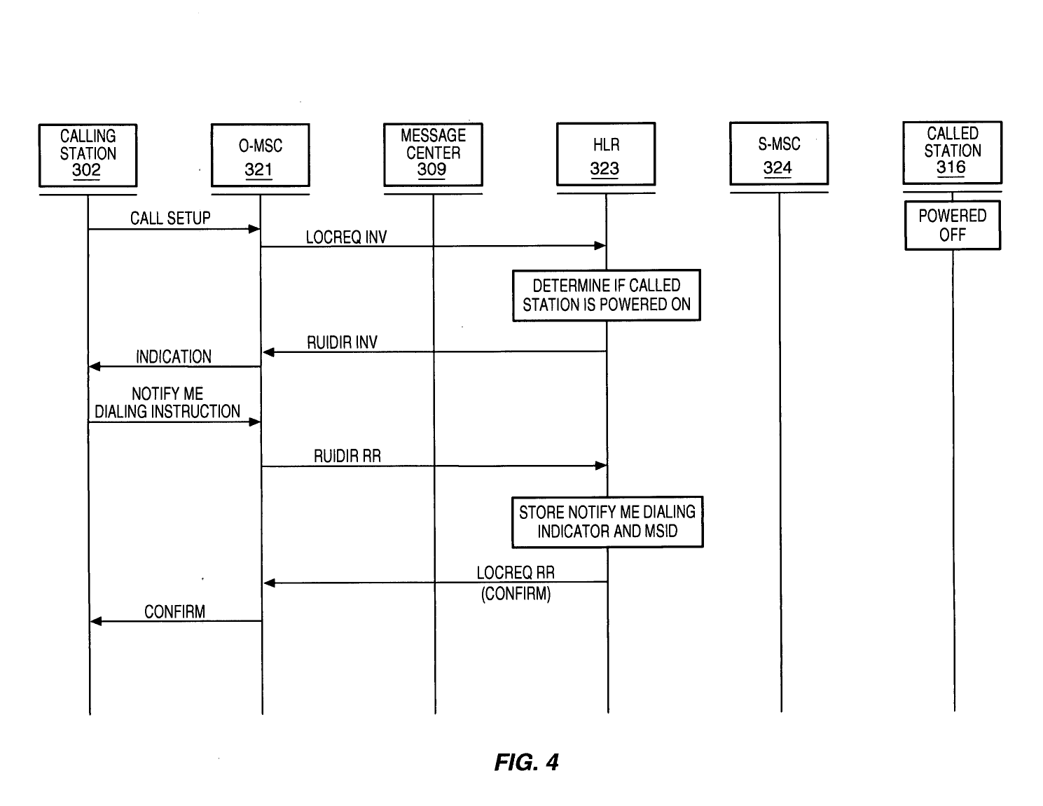

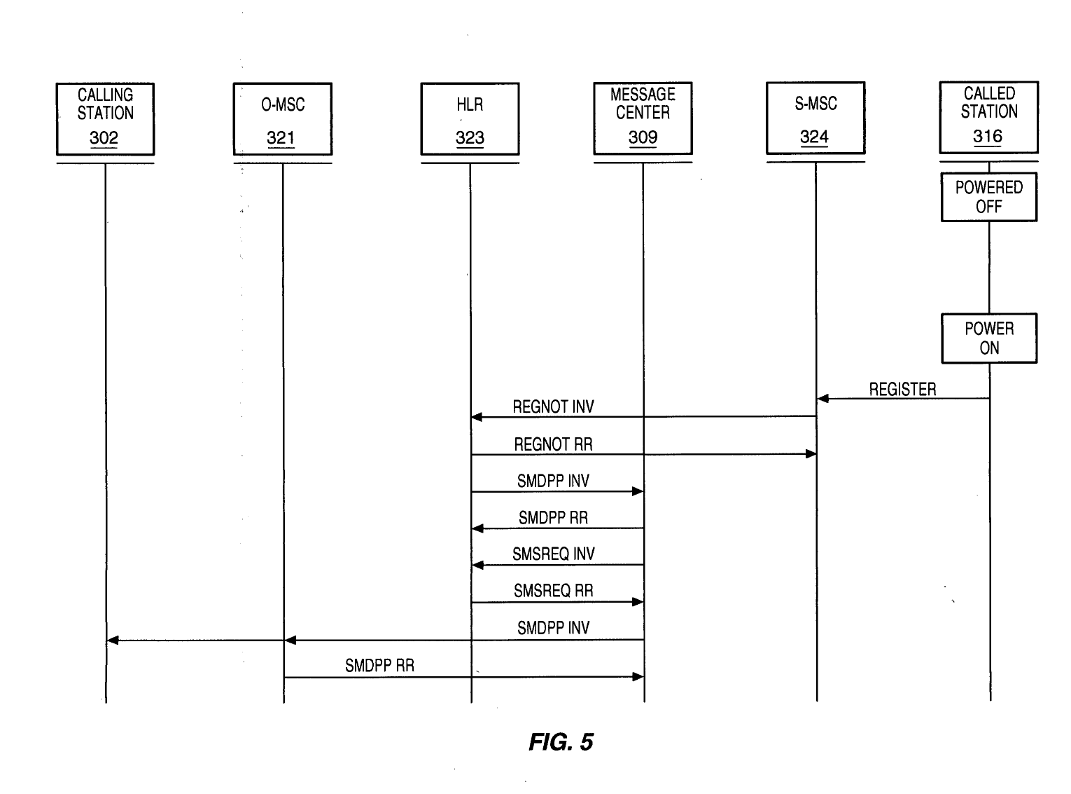

Wireless network 300 may include other components, devices, or systems not shown in FIG. 3 in order to minimize complexity. Wireless network 300 provides notify me service to station sets and other communication devices placing calls to a called station 316 that is not currently registered. FIG. 4 illustrates a process for activating the notify me service, and FIG. 5 illustrates a process for providing the notify me service once activated. The invention is not limited to the embodiments shown in FIGS. 4-5. The notify me service shown herein may be implemented by alternative embodiments.

FIG. 4 is a message diagram illustrating a process of activating notify me service in an exemplary embodiment of the invention. Calling station 302 initiates a call to called station 316 by dialing the number of called station 316. The call setup message includes the dialed number of called station 316 as well as information identifying calling station 302. O-MSC 321 receives the call setup message and transmits a LocationRequest Invoke message (LOCREQ INV) to HLR 323 that includes the number of called station 316. The LocationRequest Invoke message requests HLR 323 to determine where to route the call. Responsive to this message, HLR 323 determines that called station 316 is powered off. HLR 323 then transmits a RequestForUserInteractionDirective Invoke message (RUIDIR INV) message to O-MSC 321 indicating that called station 316 is powered off. O-MSC 321 receives the RequestForUserInteractionDirective Invoke message and transmits an indication to calling station 302 that called station 316 is powered off. For instance, O-MSC 321 may transmit an announcement to calling station 302 indicating that called station 316 is powered off. O-MSC 321 may transmit a no-answer signal to calling station 302 (e.g., rings with no answer). O-MSC 321 may also route the call to a voice mail server for called station 316, which indicates to calling station 302 that called station 316 is powered off. This advises the user of calling station 302 that called station 316 powered off and that the caller may now take the actions required to activate the notify me service if desired.

To activate the notify me service, the user of calling station 302 enters some type of notify me dialing instruction. The notify me dialing instruction depends on certain circumstances. First, assume that the user of calling station 302 is a subscriber of the notify me service, such as for a monthly fee. When the user is a subscriber, O-MSC 321 stores the last-dialed number of calling station 302 in an HLR (not shown) for calling station 302. Because the HLR for calling station 302 stores the last-dialed number of calling station 302, the user need only enter a code for activating the notify me service, such as *67, and the wireless network 300 already knows what number the notify me service is for (which is the number for called station 316 in this embodiment). Secondly, if the user is not a monthly subscriber, the user may activate the notify me service on a per-call basis. Wireless network 300 does not automatically store the last dialed number of calling station 302 if the user is not a subscriber. Therefore, the user would need to enter the code followed by the number of called station 316 to activate the notify me service. Third, assume that the user is not a monthly subscriber and that wireless network 100 provided an announcement to calling station 302 that called station 316 was powered off. For instance, the announcement may state “the party does not have their phone on, please enter a “1” if you would like to activate the notify me service for a cost of $0.75”. Responsive to the announcement, the user enters a code during the same call. Because the same call has been maintained through the announcement, O-MSC 321 already knows the last-dialed number of calling station 302. The user need only enter the code.

In response to the notify me dialing instruction, O-MSC 321 transmits a RequestForUserInteractionDirective return result message (RUIDIR RR) to HLR 323. This message includes a notify me dialing indicator which indicates that the user of calling station 302 wants to activate the notify me service. The RequestForUserInteractionDirective return result message also includes other dialing information, such as the MSID for calling station 302 and the dialed number of called station 316. HLR 323 stores the notify me dialing indicator and the MSID for calling station 302 is a subscriber record for called station 316. At this point, the notify me service is activated.

HLR 323 then transmits a LocationRequest return result message (LOCREQ RR) to O-MSC 321 that confirms that the notify me service is activated. O-MSC 321 may then transmit some type of confirmation message or tone to calling station 302 indicating that the notify me service is activated.

FIG. 5 is a message diagram illustrating a process for providing the notify me service in an exemplary embodiment of the invention. This embodiment permits calling station 302 to activate the notify me service as above discussed for the embodiment of FIG. 4. With the notify me service activated, assume that at some time called station 316 powers on. When called station 316 powers on, called station 316 registers with S-MSC 324. S-MSC 324 transmits a RegistrationNotification invoke (REGNOT INV) message to HLR 323 indicating that called station 316 has powered on. Responsive to the RegistrationNotification invoke message, HLR 323 enters an ID for S-MSC 324 in the Primary Last-Seen field of the subscriber record of called station 316. HLR 323 also accesses the subscriber record for called station 316 to determine if the notify me service has been activated. The subscriber record of called station 316 includes a notify me dialing indicator and an MSID for calling station 302 in this instance, so HLR 323 determines that calling station 302 has activated the notify me service for called station 316. HLR 323 then transmits RegistrationNotification return response (REGNOT RR) message to S-MSC 324. HLR 323 also transmits an SMSDeliveryPointToPoint invoke message (SMDPP INV) to message center 309 instructing it to transmit a message to calling station 302 indicating that called station 316 has powered on. The SMSDeliveryPointToPoint invoke message also includes the content of the message, such as text, video, etc.

Message center 309 receives the invoke message and its contents from HLR 323 and formats the received contents into a message of the type that is to be transmitted to calling station 302. The message to be transmitted by the message center 309 to the calling station 302 may be a short message or alternatively may be a multi-media message capable of generating pictures, video or large messages. Message center 309 then transmits an SMSDeliveryPointToPoint return result message (SMDPP RR) to HLR 323 acknowledging receipt of the instruction. Message center 309 also transmits an SMSRequest invoke message (SMSREQ INV) to HLR 323 requesting the ID of the O-MSC 321 serving calling station 302. HLR 323 responds with an SMSRequest return result message (SMSREQ RR) that includes the ID of O-MSC 321.

Message center 309 then transmits an SMSDeliveryPointToPoint invoke message (SMDPP INV) to O-MSC 321 that includes the message that is to be delivered to calling station 302. O-MSC 321 forwards the message generated by message center 309 to calling station 302 indicating that called station 316 is powered-on. O-MSC 321 then transmits an SMSDeliveryPointToPoint return result message (SMDPP RR) to message center 309 acknowledging receipt of the instruction. Calling station 302 can now dial called station 316 to establish a call connection.

I claim:

1. A wireless network adapted to provide notify me service, said wireless network comprising:
a network interface adapted to serve a calling station;
a called station network adapted to serve a called station;
said network interface is adapted to receive a notify me dialing instruction from said calling station placing a call to said called station not currently registered;
said network interface transmits a notify me dialing indicator to said called station network;
said called station network is responsive to the reception of said notify me dialing indicator to determine if notify me service has been activated for said called station;
said called station network monitors said called station to determine when said called station registers; and
said called station network is responsive to said determination to transmit an indication for receipt by said calling station indicating that said called station is registered.

2. The wireless network of claim 1 further including a message center wherein:
said message center is adapted to receive an instruction from said called station network; and
said message center is responsive to the reception of said instruction to transmit a message to said calling station that said called station is registered.

3. The wireless network of claim 2 wherein said called station network includes:
a Home Location Register (HLR) for said called station;
said HLR generates said instruction and transmits said indication to said message center.

4. The wireless network of claim 3 wherein:
said HLR further generates content for said message and transmits said content with said instruction.

5. The wireless network of claim 4 wherein:
said message comprises at least one of a text message, a data message, or video.

6. The wireless network of claim 3 wherein:
said HLR includes a Primary Last Seen field for said called station;
said HLR reads said Primary Last Seen field to determine when said called station registers.

7. The wireless network of claim 1 wherein:
said network interface is adapted to receive a call setup message from said calling station and to transmit said call setup message to said called station network;
said called station network is adapted to determine that said called station is not registered responsive to the receipt of said call setup message;
said called station network is adapted to transmit an indication to said network interface indicating that said called station is not currently registered; and
said network interface transmits said indication that said called station is not currently registered to said calling station.

8. The wireless network of claim 1 wherein:
said network interface transmits a Mobile Station Identifier (MSID) of said calling station along with said notify me dialing indicator to said called station network.

9. A method of operating a wireless network for providing notify me service, said wireless network comprising a network interface adapted to serve a calling station, and a called station network adapted to serve a called station, said method comprising the steps of:
receiving a notify me dialing instruction in said network interface from said calling station placing a call to said called station not currently registered;
transmitting a notify me dialing indicator from said network interface to said called station network;
determining if notify me service has been activated for said called station in said called station network responsive to the reception of said notify me dialing indicator;
monitoring said called station in said called station network to determine when said called station registers; and
transmitting an indication from said called station network for receipt by said calling station indicating that said called station is registered responsive to said determination.

10. The method of claim 9 wherein said wireless network further includes a message center, the method further comprising the steps of:
receiving an instruction in said message center from said called station network; and
transmitting a message from said message center to said calling station that said called station is registered.

11. The method of claim 10 wherein said called station network includes a Home Location Register (HLR) for said called station, the method further comprising the steps of:
generating said instruction in said HLR and transmitting said indication from said HLR to said message center.

12. The method of claim 11 wherein the method includes the further steps of:
generating content for said message in said HLR and transmitting said content with said instruction.

13. The method of claim 12 wherein:
said message comprises at least one of a text message, a data message, or video.

14. The method of claim 11 wherein said HLR includes a Primary Last Seen field for said called station, said step of monitoring said called station in said called station network to determine when said called station registers comprises:
reading said Primary Last Seen field in said HLR to determine when said called station registers.

15. The method of claim 9 further comprising the steps of:
receiving a call setup message from said calling station in said network interface and transmitting said call setup message from said network interface to said called station network;
determining that said called station is not registered in said called station network responsive to the receipt of said call setup message;
transmitting an indication to said network interface indicating that said called station is not currently registered; and
transmitting said indication that said called station is not currently registered from said network interface to said calling station.

16. The method of claim 9 wherein said step of transmitting a notify me dialing indicator from said network interface to said called station network comprises:
transmitting a Mobile Station Identifier (MSID) of said calling station along with said notify me dialing indicator to said called station network.

17. A wireless network adapted to provide notify me service, said wireless network comprising:
an originating Mobile Switching Center (O-MSC) that serves a calling station;
a Home Location Register (HLR) for a called station;
a serving Mobile Switching Center (S-MSC) that serves said called station; and
a message center;
said O-MSC receives a call from said calling station to said called station and transmits a query message to said HLR for said called station;
said HLR for said called station determines that said called station is powered off responsive to said query message, and transmits a response message to said O-MSC indicating that said called station is powered off;
said O-MSC indicates to said calling station that said called station is powered off, receives a notify me dialing instruction from said calling station, and transmits a notify me dialing indicator to said HLR for said called station;
said HLR for said called station receives said notify me dialing indicator, identifies when said called station powers on, and transmits an instruction to said message center;
said message center transmits a message, identifying that said called station powered on, to said calling station through said O-MSC responsive to said instruction.

18. The wireless network of claim 17 wherein said HLR for said called station transmits content for said message to said message center with said instruction.

19. The wireless network of claim 17 wherein said message comprises a text message.

20. The wireless network of claim 17 wherein said message center comprise one of a Short Message Service Center or a Multi-Media Center.
